(19) United States
(12) Patent Application Publication
(10) Pub. No.: US 2004/0068509 A1
(43) Pub. Date: Apr. 8, 2004

(54) Data transfer and/or transformation system and method

(76) Inventors: Peter William Garden, Auckland (NZ); Darren Michael Rowley, Richmond (GB); Anthony Jason Nigro, Auckland (NZ)

Correspondence Address: MERCHANT & GOULD PC, P.O. BOX 2903, MINNEAPOLIS, MN, 55402-0903, US

(21) Appl. No.: 10/466,928

(22) PCT Filed: Jan. 18, 2002
(86) PCT No.: PCT/NZ02/00004

(30) Foreign Application Priority Data
Jan. 19, 2001 (NZ) 509483

(51) Int. Cl. G06F 17/00

(52) U.S. Cl. 707/100

(57) ABSTRACT

A method for processing data. Meta-data descriptors (15, 18) are defined to describe the data either by the user (17) or automatically using a meta-data connector (16). A meta-data descriptor describes the structure of data including field names (1, 4). A meta-data connector describes how to access the data. Different types of meta-data connectors (10, 11, 12) exist for different types of data such as JDBC and XML. An interactive user application (23) is utilised to facilitate the definition of a process. A process consists of certain operations (7) in relation to meta-data descriptors (2, 5) such as transformation of data from one field name to another. A component (8, 26) is provided to process data in accordance with the defined process. A computer system and software for implementing the method is also disclosed.

### FIELD OF THE INVENTION

The invention relates to methods of processing data. An abstract object layer is utilised in relation to data to define a process for the data. A user may interactively define the process using meta-data.

### BACKGROUND TO THE INVENTION

In many distributed computer systems there is a need to transfer data from one computer system to another computer system, a remote computer system. Often the data is stored in a different format on each system.

When dealing with certain types of structured information rules can be established to transform data stored in a first format to data format according to a second format. U.S. Pat. No. 6,085,196 discloses a method which enables mapping relationships to be defined between structured information in a first format and structured information in a second format, particularly between SGML and HTML. In this patent a mapping database is defined by a user which defines the mapping relationship between elements (e.g. fields) of a first format and elements (e.g. tags) of a second format. This patent deals with structured data where elements are defined within a description document (e.g. DTD or XSD). Data from a source data source is then parsed utilising the transformations defined in the mapping database to produce target data, formatted according to the second format. The method of this patent involves the definition of rules for transforming defined generic data elements according to a first format to defined generic data elements according to a second format.

Often there is a need to transport or transform data to another format. This need can arise where data, stored without meta-data, must be transported or transformed to a format where the meta-data is defined.

The method of U.S. Pat. No. 6,085,196 does not provide means of transforming data where the elements are not defined within a description document (i.e. SGML elements and HTML tags). Furthermore, the method only provides for one to one mapping of source and target fields.

It is an object of the present invention to provide a flexible method and system for enabling the transfer or transformation of data between a wide variety of data formats or to at least provide the public with a useful choice.

According to a first aspect of the invention there is provided a computer implemented method of processing data comprising the steps of:

i) defining meta-data descriptors to represent the data;

ii) in an interactive user application defining a process associated with at least one of the meta-data descriptors; and

iii) processing the data in accordance with the defined process.

A meta-data descriptor may describe formatting, relationships, structure, and attributes relating to data. Meta-data descriptors may be defined by querying a structured database, examining an XML or HTML file, querying an XML schema or based on contextual criteria.

Access to data may be assisted by a meta-data connector. A specific meta-data connector exists for each data. For example, a text file where there are three fields being Name, ID, and Address will have a text file meta-data connector that specifies the location of the text file, any other information required to access that text file, and any information required to access text files generally. Another text file with different data but the same fields will use the same meta-data connector. A different text file with different fields will use a different text file meta-data connector. A database file accessed using JDBC will use a JDBC meta-data connector.

Processing data can include manipulating data, transforming data, and/or transferring data.

Preferably the method involves the transformation of data from a source data source to a target data source. A data source is data accessed through a meta-data connector. The interactive user application displays source meta-data descriptors and target meta-data descriptors and allows a user to define rules for transforming data represented by the source meta-data descriptors into data represented by the target meta-data descriptors. Transformation may be performed at times according to a user defined schedule. Data may be obtained from remote sources and remote devices may perform part of the transformation operation. Transformation may be initiated by a trigger event at a remote device which may be another computer system or software program that sends a “signal” to start the process.

Target data elements may be supplied with the associated target meta-data descriptors to a target data source or a file containing the target data elements may be sent to the target data source. By using different types of meta-data connectors the method may enable transformations between different types of data including JDBC, text, EDI, IDOC, XML and HTML files, dynamic web pages, telnet terminal sessions, web services, and real-time data streams.

According to a further aspect of the invention there is provided a computer implemented method of transforming selected data from one or more source data sources to one or more target data sources comprising the steps of:

(i) defining meta-data descriptors for the source data sources and for the target data sources;

(ii) in an interactive user application defining a transformation process between the source meta-data descriptors and the target meta-data descriptors; and

(iii) transforming source data extracted from the source data sources in accordance with the defined transformation process to generate target data for supply to the target data sources.

According to a further aspect of the invention there is provided a computer system for processing data comprising:

(i) a processor;

(ii) memory of supplying data to the processor;

(iii) an input device for providing user input to the processor;

(iv) a display device for displaying information from the processor;

v) an application residing in memory which, when executed by the processor, is responsive to user input to define meta-data descriptors to represent data and to define a process associated with at least one of the meta-data descriptors; and to process the data in accordance with the defined process.

The invention will now be described by way of example with reference to the accompanying drawings in which:

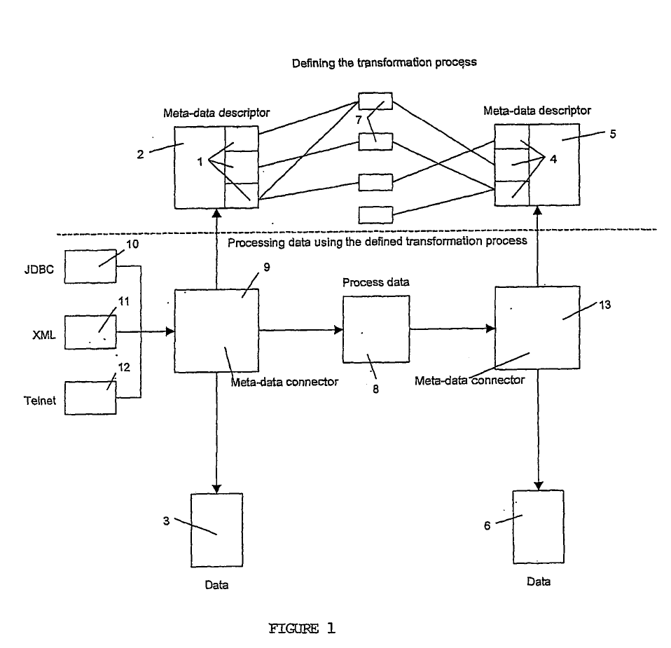

FIG. 1: Shows a functional diagram illustrating the method for defining the transformation process and processing the data.

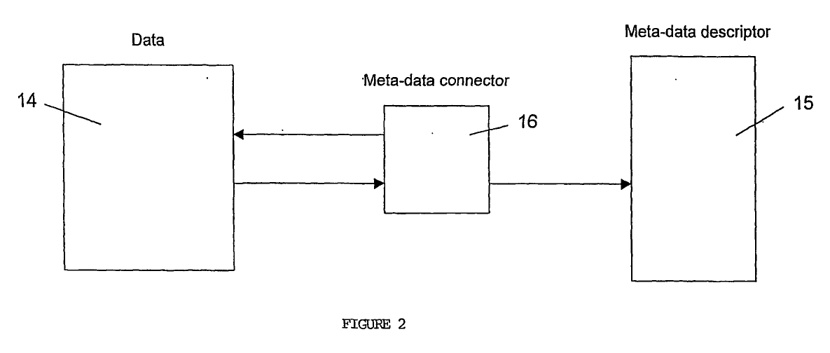

FIG. 2: Shows a functional diagram illustrating the method for defining meta-data descriptors by examining the data through a meta-data connector.

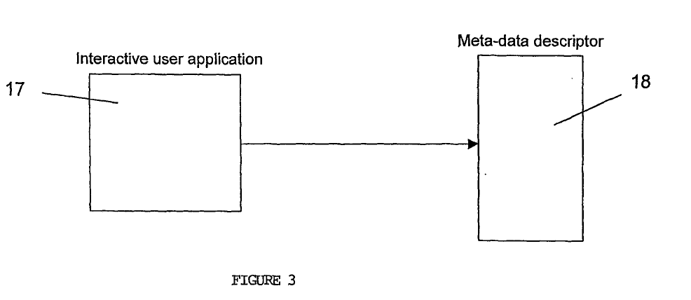

FIG. 3: Shows a functional diagram illustrating the method for defining meta-data descriptors with user assistance.

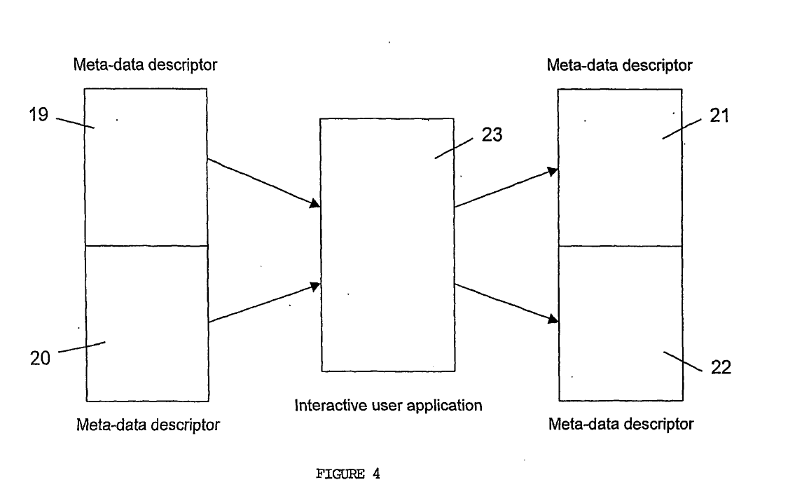

FIG. 4: Shows a functional diagram illustrating the method for defining the transformation process.

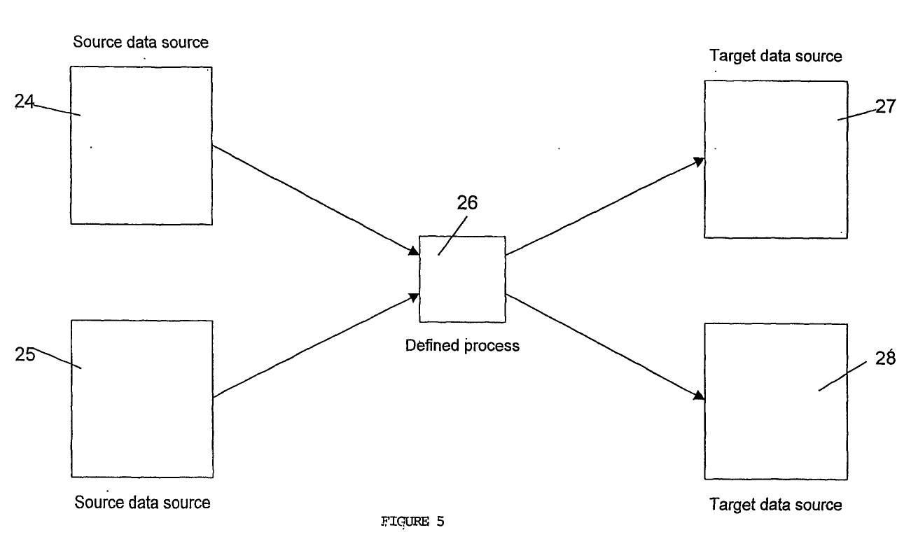

FIG. 5: Shows a functional diagram illustrating the method for transforming data according to the defined transformation process.

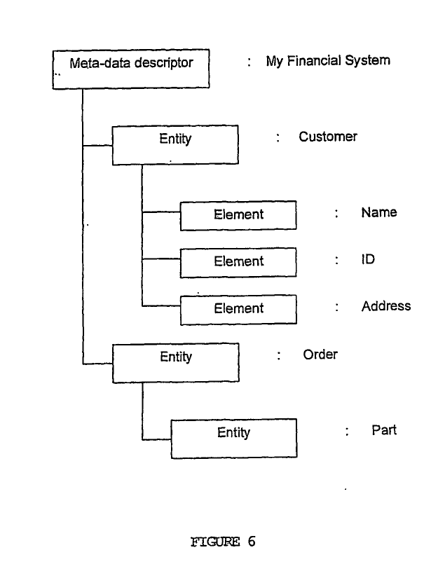

FIG. 6: Shows an example of a meta-data descriptor.

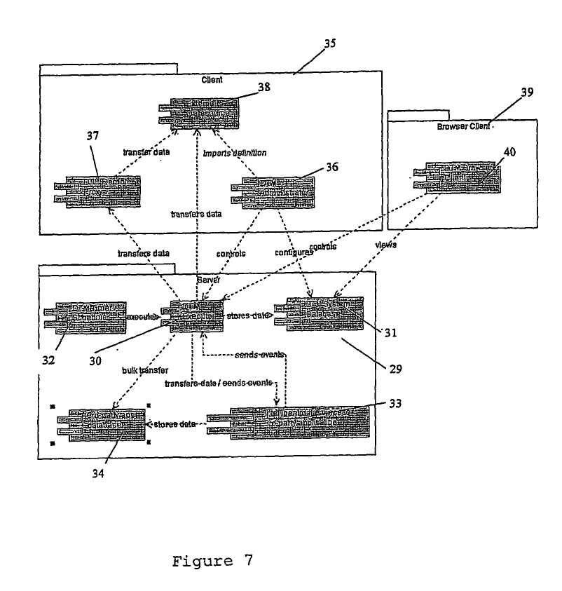

FIG. 7: Shows the components of a system for implementing the method shown in FIGS. 1 to 5.

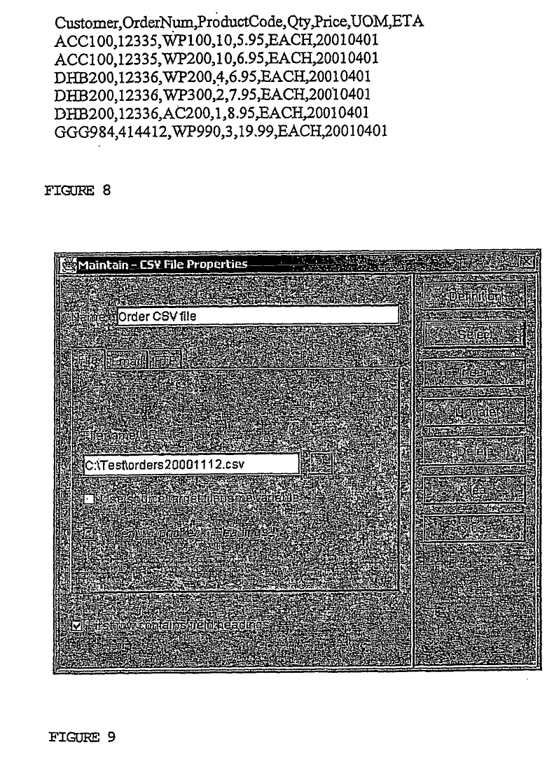

FIG. 8: Shows an example of source data as a CSV file.

FIG. 9: Shows a screen illustrating a user creating a meta-data connector for the CSV file.

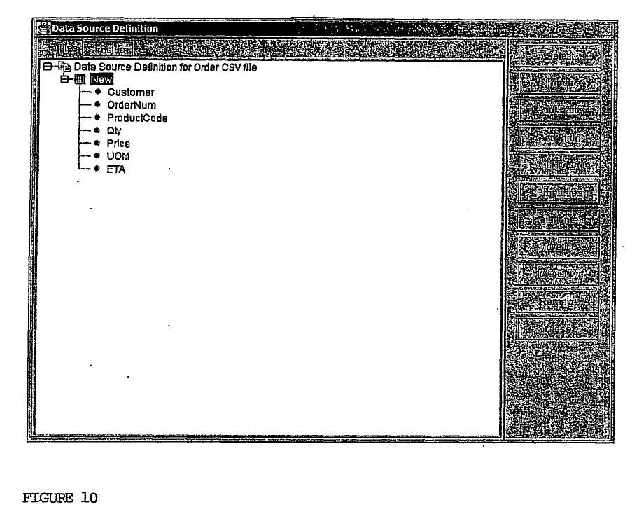

FIG. 10: Shows a screen illustrating a meta-data descriptor for the CSV file.

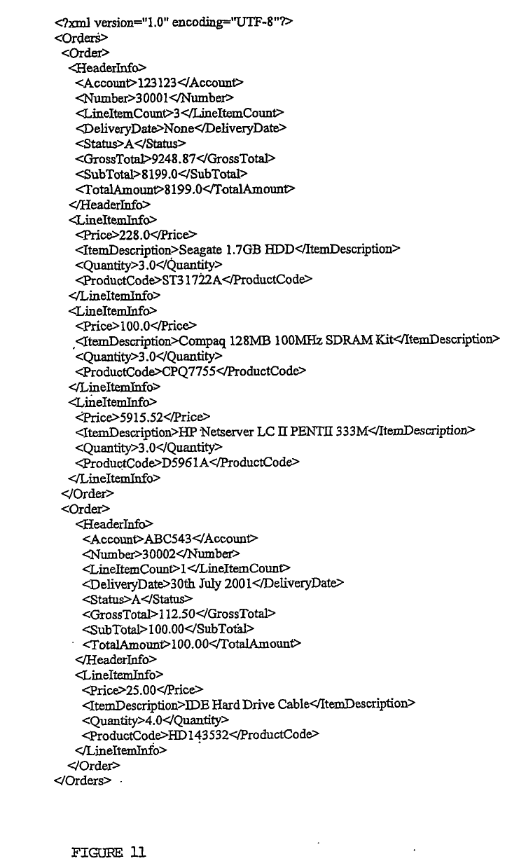

FIG. 11: Shows an XML file from which a meta-data descriptor will be extracted

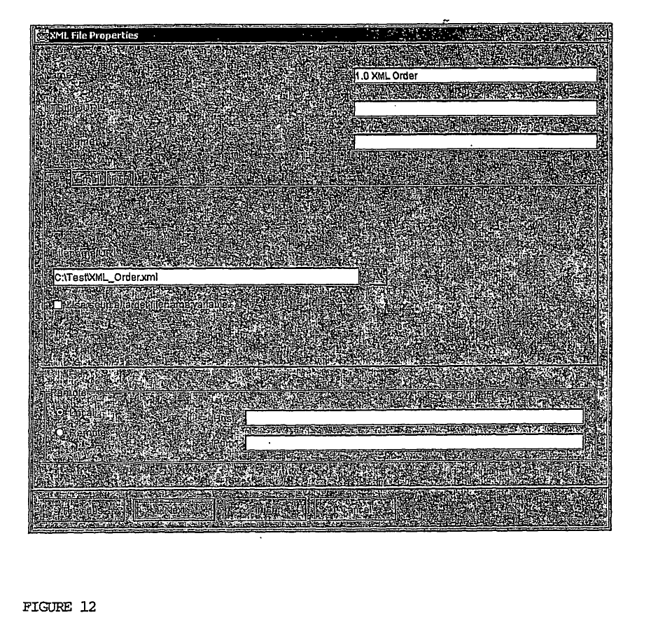

FIG. 12: Shows a screen illustrating a user creating a meta-data connector for the XML file.

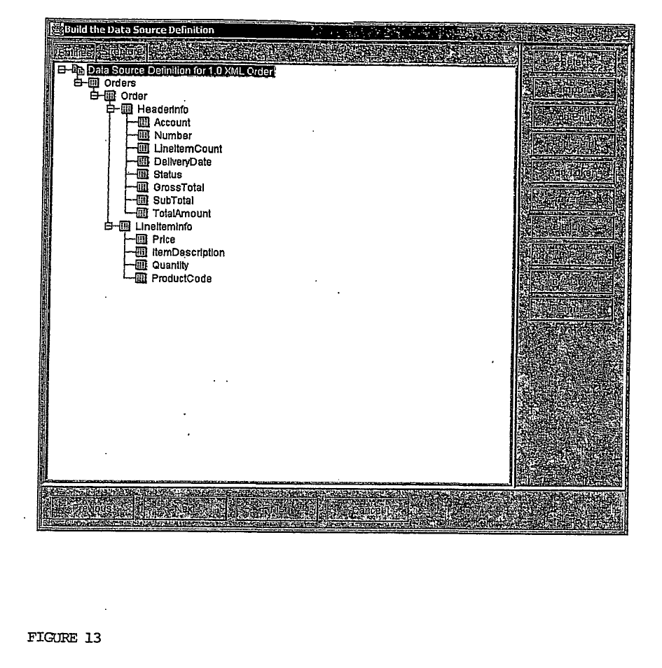

FIG. 13: Shows a screen illustrating the meta-data descriptor for the XML file.

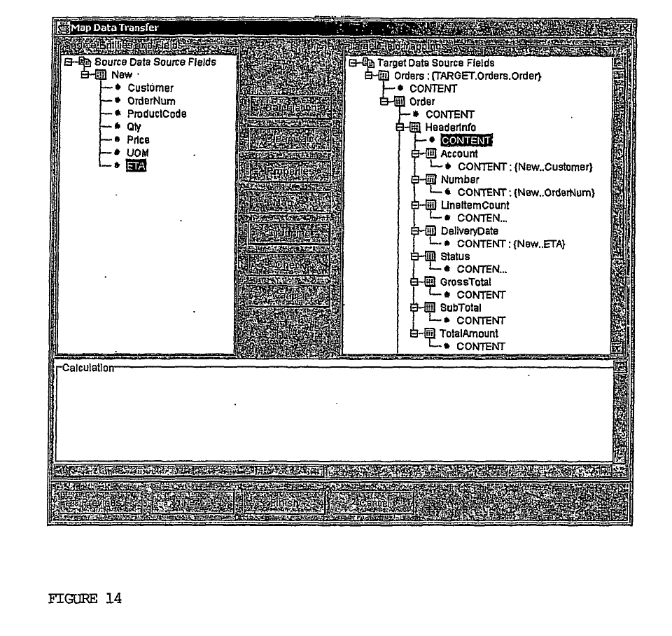

FIG. 14: Shows a screen illustrating the interactive user application for defining a transformation process by dragging source elements to target elements and establishing a one-to-one direct map.

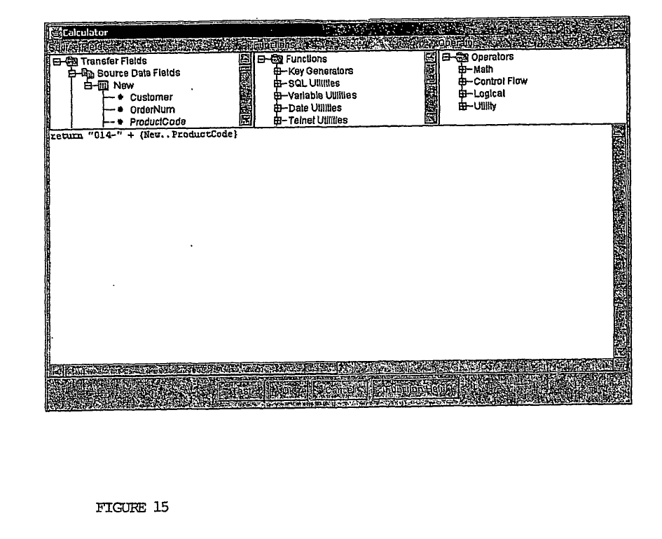

FIG. 15: Shows a screen illustrating the interactive user application for creating calculation operations.

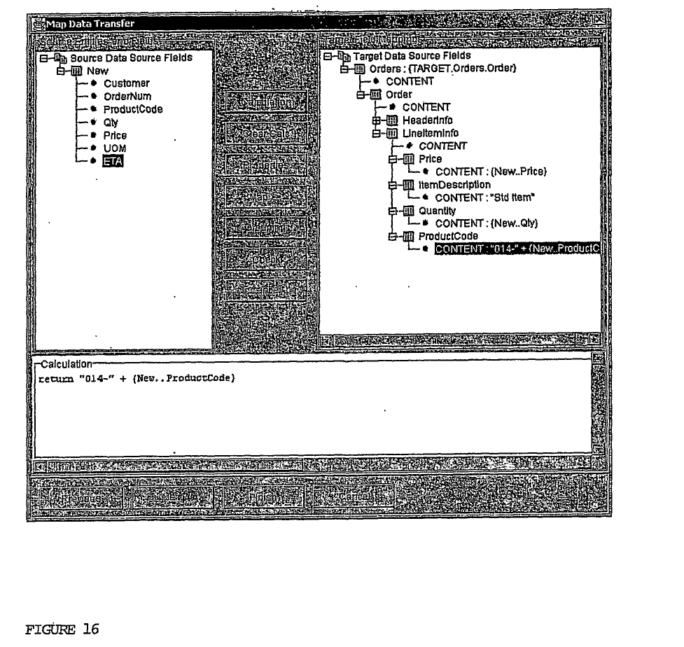

FIG. 16: Shows a screen illustrating the interactive user application where target elements resulted from by direct one-to-one maps with the source elements, transformations from the source elements, and calculated data.

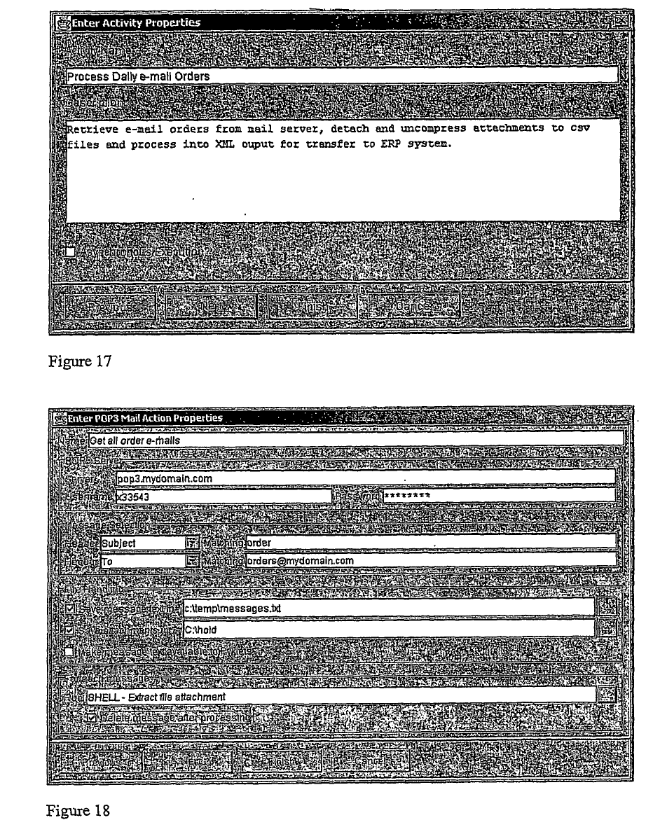

FIG. 17 Shows a screen illustrating the creation of an activity.

FIG. 18: Shows a screen illustrating the creation of an action.

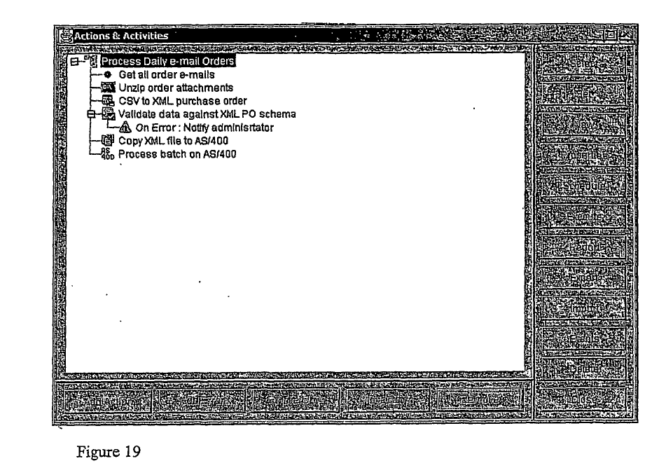

FIG. 19: Shows a screen illustrating constructing an activity from actions.

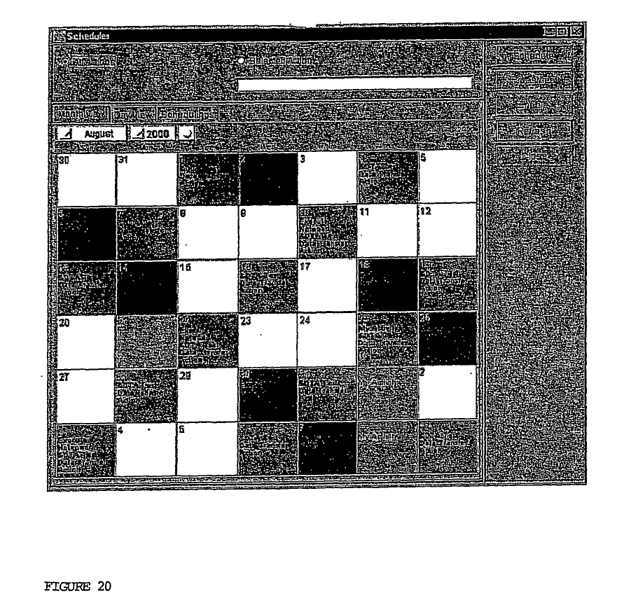

FIG. 20: Shows a screen illustrating the scheduling application when scheduling dates for activities and actions.

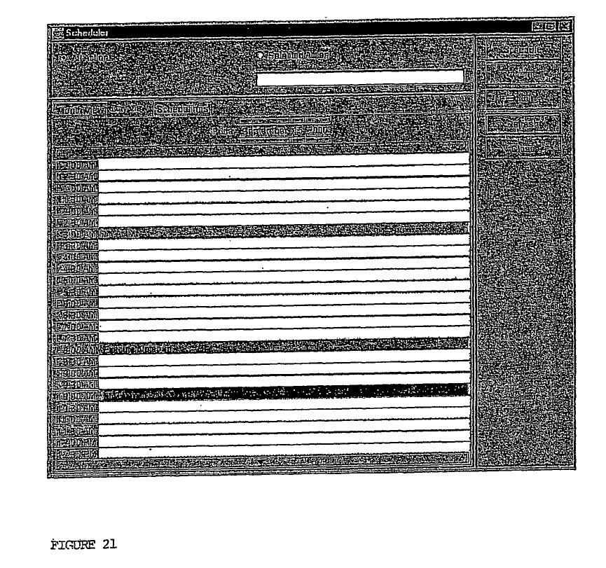

FIG. 21: Shows a screen illustrating the scheduling application when scheduling times for activities and actions.

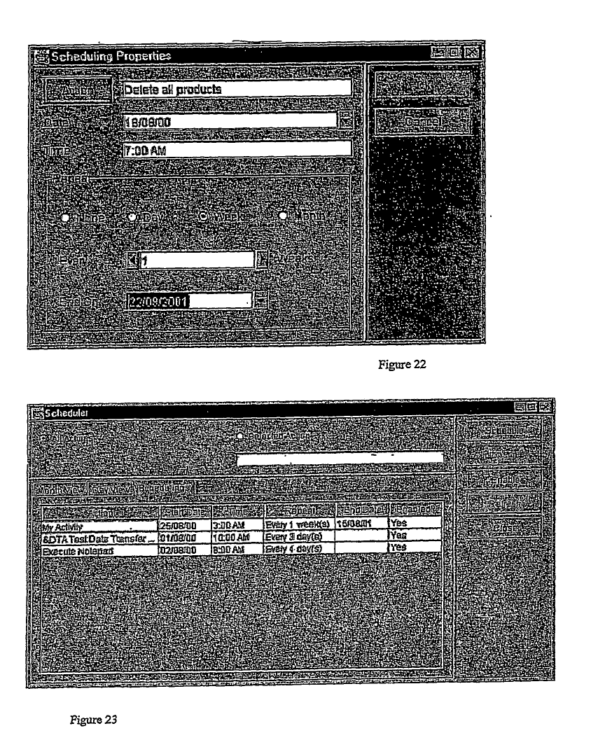

FIG. 22: Shows a screen illustrating the scheduling application when scheduling an action.

FIG. 23: Shows a screen illustrating a function of the scheduling application.

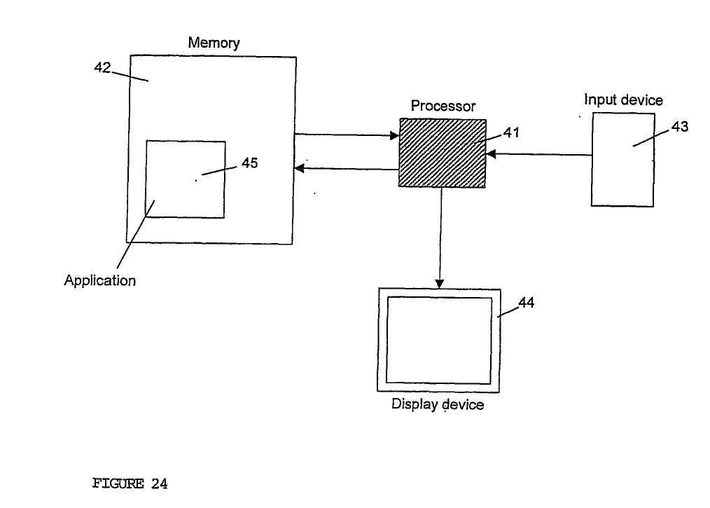

FIG. 24: Shows the components of the simplest system for implementing a method shown in FIGS. 1 to 5.

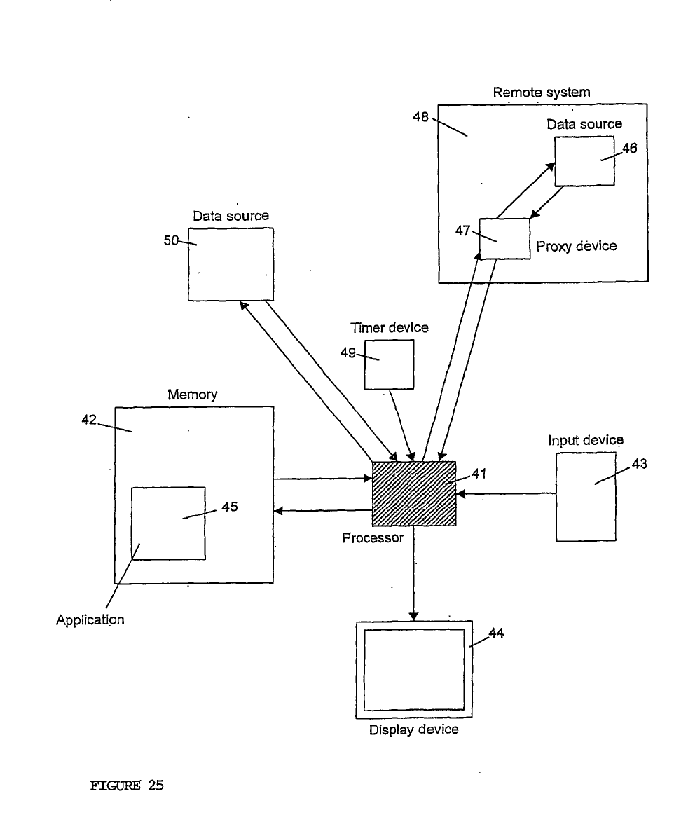

FIG. 25: Shows the components of a system for implementing the method shown in FIGS. 1 to 5.

The present invention relates to a method which enables the transfer of data between distributed devices and the transformation of data between a first format and a second format. The method involves the creation of an abstract object layer between the source and target data sources to define the required transformation operations. This provides great flexibility and enables users to define required transformations for specific data types and transformation operations.

Referring to the example shown in FIG. 1, the transformation process is defined by mapping elements 1 represented by meta-data descriptors 2 for the source data 3 to elements 4 represented by meta-data descriptors 5 for the target data 6. The definition of the transformation process is assisted by a user within an interactive user application. The transformation process may involve mappings which transform or manipulate the source data elements by applying various operations 7 including programmatic and arithmetic operations.

The defined transformation process 8 uses a meta-data connector 9 to access the source data 3. The meta-data connector contains specific information about the source data including how to access the source data. For example, if the source data is to come from a telnet session the meta-data connector may include logon information, information about key strokes required to access the data, and information about how to handle error exceptions received from the telnet session.

In addition to containing specific information about the particular source data, the meta-data connector contains general data for accessing data of that type. For example, a JDBC meta-data connector type 10 used for JDBC data, a XML meta-data connector type 11 used for XML data, or a telnet meta-data connector type 12 used for telnet data.

Data resulting from the transformation process is inserted into the target data 6 using a metadata connector 13.

Referring to the example shown in FIG. 2, the first step is to identify the location of the data 14. This may be local or remote data. Meta-data descriptors 15 for that data may be defined by using a meta-data connector 16 to examine the data.

Referring to the example shown in FIG. 3, meta-data descriptors 18 may be defined with the assistance of a user in an interactive user application 17.

Structured data is data where meta-data is recorded within the data, such as a database. Unstructured data is data where meta-data is not recorded within the data.

Structured data may be examined to determine the meta-data descriptors. For example, a database may be queried to extract meta-data descriptors. For unstructured data, such as text files, rules must be established to enable the meta-data descriptors to be defined. A user may identify the location of the data and the manner in which the data should be parsed to define the meta-data descriptors.

For unstructured data, such as text files, telnet terminal sessions, or HTML pages, contextual criteria may be specified. For example it may be specified that the first row contains field headings. Record terminators and field separators may also be defined. With this information it is possible to parse the data and return field names, data types, data structure and other relevant information to construct a meta-data descriptor.

The data may be source data from which data is to be extracted or target data to which data is sent. In the process described above identification of all target meta-data descriptors and source meta-data descriptors for the target and source data is possible whether the data is structured or unstructured.

In the example shown in FIG. 4 a process for transforming data represented by the meta-data descriptors is defined. Any number of steps within the process may be defined by execution. The source meta-data descriptors 19,20 are preferably displayed on one side of the screen and the target meta-data descriptors 21,22 displayed on the other side of the screen. With an interactive user application 23 a user may then define mapping relationships between source meta-data descriptors and target meta-data descriptors or any number of operations that must be performed to map source meta-data descriptors to target meta-data descriptors, for example an operation to combine data represented by two source meta-data descriptors to result in data represented by two source meta-data descriptors to result in data represented by one target meta-data descriptor. Mapping may be performed using a drag and drop operation or another method to associate source and target meta-data descriptors.

Certain operations may involve calculations including the concatenation or breaking up of data represented by source meta-data descriptors to map to a target meta-data descriptor. Target meta-data descriptors can also be specified as calculations without any relationship whatsoever to the source meta-data descriptors for example, where the target data needs to contain constant or calculated values.

In the example shown in FIG. 5 a source data source 24 and a source data source 25 are shown. It will be appreciated that any number of data sources may be utilised. The data transformation manager using the defined process 26 transforms the source data elements into target data elements of target data source 27 and target data source 28. Again, it will be appreciated that any number of target data sources may be created or utilised to accept data.

Transformations may be performed locally or by a remote transformation manager. Where a remote transformation manager is employed data associated with selected source meta-data descriptors must be supplied to the remote transformation manager which returns data relating to the selected target meta-data descriptors. The remote transformation manager may further require data from a remote data source to complete a transformation. Software may be installed on a remote computer connected by a TCP/IP connection which enables data to be easily extracted from the remote computer and transported to the local computer by one of a number of transport protocols such as SOAP over HTTP or RMI. Transport protocols may incorporate authentication and encryption to allow the remote computer to communicate securely with the local computer.

Data represented by target meta-data descriptors may be mapped or combined according to a specified function to produce the required target data elements. The transformation software may include a “calculator” which determines the value of target data elements based upon source data and/or target data elements. The calculation may be a simple one to one mapping or use complex predefined or user defined functions. Preferably, the calculations are performed using a scripting language such as Phython, Jython, Javascript or VB script. The calculations may include mathematical operators (multiply, divide, add, subtract, assignment, mod, brackets) string operators (concatenation), logical operators (equal, not equal, less than, greater than, less than or equal, greater than or equal, AND, OR, XOR), flow control operators (if, if . . . else, if . . . else if . . . else, for, for . . . else, while, while . . . else, break, continue, pass) and utility operators (number to string conversion). Calculations may include mathematical functions (abs (val), complex (real[, imag]), pow (xy), divmod (a, b), pi, e, trig functions, exponential functions, logarithmic functions etc). Calculations may also include calendar and date and time functions, string functions, utility functions, list functions, key generators, SQL utilities, variable utilities and area handling utilities.

Target data elements may be sent to respective target data sources with their associated target meta-data descriptors or a fie containing the target data elements may be sent to the relevant target data sources.

Referring now to FIG. 6 an example of a meta-data descriptor is shown.

Referring now to FIG. 7 a system for implementing the method of the invention is shown. A server 29 is seen to include an Executor component 30, a Database 31, a Timer 32 and a 3^{rd} Party Application accessed through an intelligent datasource 33 and its associated Database 34.

A client computer 35 is seen to include an Administrator component 36, a Remote data transfer component 37 and a data source 38. The remote data transfer component 37 is a lightweight component and is connected to server 29 via a TCP/IP connection over a WAN. The remote data transfer component 37 enables executor component 30 to call data from client computer 35 to facilitate a connection and the transfer of data from a remote computer where no direct connection exists.

Administrator component 36 may communicate with the executor component 30 to allow a remote user to schedule actions. These actions may then be performed by executor module 30 at specified times or upon the happening of specified events. Trigger events may include communications from a remote device such as client computer 35. A client computer 39 is seen to have a browser application 40.

The system enables the transport and transformation of data between databases 34 and 38. The Administrator module 36 allows a client to define actions as described above in relation to FIG. 3. Administrator module 36 also enables the actions to be scheduled to be executed at specified times or upon specified events. The actions and schedule may be stored an server 29. Executor module 30 executes the specified actions as set out in the schedule at specified times or upon receipt of event information the specified actions are executed. The event mechanism may allow an external application such as the 3^{rd} Party Application to initiate workflow activities or actions in the Executor module 30. Data is obtained from Database 34 and, where required, information is requested by the Executor module 30 via the remote data transfer component 37 to query data source 38 and return the required data to executor module 30. The required data transformations are performed and the target data elements are transferred to data source 38.

A worked example illustrating the creation of meta-data connectors, the creation of meta-data descriptors, and the definition of a process for transforming source data to target data all by the administrator component 36 as seen by a user will now be described with reference to FIGS. 8 to 16.

Referring firstly to FIG. 8 a CSV file is shown. The CSV file contains field headings in the first row and the subsequent rows contain data relating to “Orders”. This file will be used in the transformation process in FIG. 14 as the source data.

In FIG. 9 a screen is shown where a user defines the meta-data connector for the CSV file. The data source is given the name “Order CSV file” and the file name or URL at which the file can be called is given. The user has also selected the “First row contains field headings” box. This enables the Executor module 30 to query the CSV file and recover the field headings. The field headings form the meta-data descriptor for this data.

The “Select” button is then actioned and the screen shown in FIG. 10 shows the fields extracted from the CSV file after the “Import” button is actioned. The source field names “Customer” to “ETA” are listed on the screen.

In FIG. 11 an XML file is shown.

In FIG. 12 the meta-data connector for an XML target data source is defined by the user. The user enters the name of the data source as “1.0 XML Order” and a Filename/URL is entered. In this case the meta-data descriptor will be extracted from the XML file shown in FIG. 11.

In FIG. 13 the meta-data descriptor that is going to be used as the target meta-data descriptor is displayed. In this case the meta-data descriptor has two entities “Headerinfo” and “LineItemInfo” as children of an entity “Order” which is in turn a child of entity “Orders”. The entity “Headerinfo” has target fields names “Account” to “TotalAmount”. The entity “LineItemInfo” has target field names “Price” to “ProductCode”. Additional entities and field names may be added if necessary.

In FIG. 14 the transformation process is defined. On the left side the source entity and field names from the meta-data descriptor for the CSV file are displayed. On the right side the target entities and field names from the meta-data descriptor extracted from the XML file are displayed. The user may map source field names to target field names. In FIG. 14 the user has clicked and dragged source field names to a corresponding target field name. This creates a direct one-to-one mapping. In the example the user has dragged “Customer” to “Account”. The user can map one or more source fields to one target field or one source field to many target fields. The user may also define certain calculations to result in data for target field names by pressing the Calculation button.

In FIG. 15 the calculation component is shown. Data for target field names can result from calculations made in relation to source fields or calculations resulting from constant data, data from another source, or other data unrelated to data from the source fields.

FIG. 16 shows another example of the definition of a transformation process. In this example the user has directly mapped the “Price” source field to the “Price” target field and the “Qty” source field to the “Quantity” target field. The user has used the calculation component to enter a constant value “Std Item” in the “Item Description” target field and prefixed “014-” to data from the “ProductCode” source field to result in the “ProductCode” target field.

The Administrator module 36 allows a client to define activities. An activity consists of actions. The actions may be arranged according to a script. The actions can consist of data transfer actions and other actions that control the computer environment, send e-mails, or handle errors. The actions can consist of functions that monitor or control the current activity or other activities, execute programs or iterate other actions, or other standard programmatic functions. New types of actions can be created by the user. For example the user may require a particular network connection to be operational before a defined process to transform data is started.

One of the actions within an activity may be a defined process to transform data as described in FIG. 5.

The execution of actions or activities can be dependent on a trigger event. A trigger event includes events generated by a remote system, a scheduler application, or a specified change on the local system.

FIG. 17 shows the creation of an activity. The user gives the activity a name, in this example “Process Daily e-mail Orders”, and a description.

FIG. 18 shows a screen where a user is defining a particular action. The action is a POP 3 e-mail action that logs into a mail server and retrieves e-mails matching certain header fields defined by the user, and extracts the e-mail message and attachments to the local hard drive.

FIG. 19 shows how an activity may be composed or various actions. In this example the process is:

Get order e-mails from the POP3 server—“get all order e-mails”.

Unzip attachments to extract the CSV files containing orders—“Unzip order attachments”.

Convert the CSV orders to an XML format—“CSV to XML purchase order”. This step represents a defined process to transform data as in FIG. 5.

Validate the resulting XML data against an XML schema to ensure the orders contain valid data—“Validate data against XML PO schema”.

Copy the resulting XML file to an AS/40 system—“Copy XML file to AS/400”.

Execute a command on the AS/400 that will send the orders into an ERP system on the AS/400—“Process batch on AS/400”.

The scheduling component may include a graphical user interface as shown in FIGS. 20 to 23. FIG. 20 shows a screen listing for defined actions. FIG. 21 shows a screen showing the scheduling of actions in a calendar format. FIG. 20 shows the action scheduled for a day. Users can view the scheduling of actions in any desired format.

Referring to FIG. 21 a screen showing scheduling properties is shown. A user can select an action, a date and time for execution of the action and in the “Repeat” portion define the periodicity of the action. Actions may also be set up to be triggered upon the occurrence of trigger events including communications from external devices, changes in data etc. FIG. 23 shows a schedule listing a series of actions.

FIG. 24 shows a possible computer system implementing the method. The method may be deployed on computer hardware comprising an Intel processor 41, SDRAM memory 42, a keyboard and mouse input device 43, a computer monitor visual display device 44 and an application 45 residing in the SDRAM memory.

FIG. 25 shows another possible computer system for implementing the method. The method may be deployed on computer hardware comprising an Intel processor 41, SDRAM memory 42, a keyboard and mouse input device 43, a computer monitor visual display device 44 and an application 45 residing in the SDRAM memory. The computer system may include a database 46 residing on a remote system which the processor can access through a remote transfer component proxy device 47 also residing on the remote system 48. The computer system also includes a hardware clock timer device 49 and a local database 50.

Those skilled in the art will appreciate that the method may be deployed on a computer system with more than one processor, more than one memory component, other types of input devices or more than one database located on remote systems or locally. Those skilled in the art will appreciated that the method may be deployed on a network such that some components may communicate to each other over a network such as a LAN or WAN using a protocol such as TCP/IP.

It will be seen that the invention provides a convenient means for transferring data formatted according to a first format to another system in which data is stored in a second format. The invention also provides a method and system which provides great flexibility for a user in the transformation of a wide range of data source formats to a wide range of target source formats. The invention also provides a method whereby changes in the way data is accessed does not affect the defined process as data access information is isolated to the meta-data connector for that data. The invention is platform independent as the remote data transfer component can be deployed on any system and all transformations managed by a central server. Furthermore, due to the abstract nature of the meta-data connectors and the interactive user interface used to define transformations, inexperienced 3^{rd} party programmers can add new meta-data connector types and define new transformation processes easily. The ability of the invention to define meta-data connectors enables the use of the invention for legacy systems which use out-dated or unusual data access methods, such as telnet sessions. The access complexity handled by the meta-data connectors enables the invention to be used to manage data from a source which requires complex error handling capabilities.

Where in the foregoing description reference has been made to integers or components having known equivalents then such equivalents are herein incorporated as if individually set forth.

Although this invention has been described by way of example it is to be appreciated that improvements and/or modifications may be made thereto without departing from the scope of the invention as defined in the appended claims.

1. A computer implemented method of processing data comprising the steps of:
iv) defining meta-data descriptors to represent the data;
v) in an interactive user application defining a process associated with at least one of the meta-data descriptors; and
vi) processing the data in accordance with the defined process.
Meta-Data Connectors

2. A method as claimed in claim 1 wherein access to the data is through a meta-data connector.

3. A method as claimed in claim 2 wherein the meta-data connector comprises information about how to access the data.

4. A method as claimed in any one of claims 2 to 3 wherein the information includes database, ftp, mail server, web page or telnet logon procedures, navigation procedures, location of the data, and location of data within the data.

5. A method as claimed in any one of claims 2 to 4 wherein different types of meta-data connectors are used to access different types of data.

6. A method as claimed in any one of claims 2 to 5 wherein the meta-data connectors are defined by a user in an interactive user application.
Meta-Data Descriptors:

7. A method as claimed in one of the preceding claims wherein the meta-data descriptors represent the structure of the data.

8. A method as claimed in claim 7 wherein the structure of the data consists of entities and their elements and any relationships between the entities or between the elements.

9. A method as claimed in any one of the preceding claims wherein the meta-data descriptors describe rules to identify specific elements of data and specific types of data within the data.

10. A method as claimed in claim 9 wherein at least one rule specifies contextual criteria.
Defining Meta-Data Descriptors

11. A method as claimed in any one of the preceding claims wherein the meta-data descriptors are obtained by examination of the data.

12. A method as claimed in any of the preceding claims wherein meta-data descriptors are obtained by examination of one or more secondary sources.

13. A method as claimed in any one of the preceding claims wherein the meta-data descriptors are defined with the assistance of a user through an interactive user application.

14. A method as claimed in any one of the preceding claims wherein the meta-data descriptors are defined by any combination of the following operating in conjunction: examination of the data, assistance of a user through an interactive user application, and examination of one or more secondary sources.

15. A method as claimed in any one of the preceding claims wherein the meta-data descriptors are defined by the examination of a database by querying the database.

16. A method as claimed in any one of the preceding claims wherein the meta-data descriptors are defined by examination of a series of keystrokes and screen captures resulting from a telnet session with the assistance of a user through an interactive user application.

17. A method as claimed in any one of the preceding claims wherein the meta-data descriptors are defined by examination of an XML structure or schema.

18. A method as claimed in any one of the preceding claims wherein the meta-data descriptors are defined by examination of an EDI or IDOC file.

19. A method as claimed in any one of the preceding claims wherein the meta-data descriptors are defined by parsing the data and automatically identifying the meta-data.

20. A method as claimed in any one of claims 2 to 19 wherein examination of the data occurs through the use of the meta-data connector.
Defining the Process

21. A method as claimed in any one of the preceding claims wherein the defined process is created in an interactive user application that displays meta-data descriptors and allows a user to define steps for processing the data represented by the meta-data descriptors.

22. A method as claimed in claim 21 wherein the process defines steps for transforming data represented by source meta-data descriptors into data represented by target metadata descriptors.

23. A method as claimed in any one of claims 21 to 22 wherein a defined step involves manipulations or transformations occurring via programmatic or arithmetic methods.

24. A method as claimed in any one of claims 21 to 23 wherein a defined step involves an arithmetic calculation, string transformation, key generation, an SQL calculation, a calendar calculation, a date/time calculation, a financial calculation or a statistical calculation.

25. A method as claimed in any one of claims 21 to 24 wherein the defined step is performed by a device that is remote from the device initiating the step.

26. A method as claimed in any one of claims 21 to 25 wherein a defined step includes the mapping of source meta-data descriptors to target meta-data descriptors.

27. A method as claimed in claim 26 wherein at least one source meta-data descriptor is mapped to a plurality of target meta-data descriptors.

28. A method as claimed in claim 26 or claim 27 wherein at least one source meta-data descriptor is mapped to target meta-data descriptors of more than one target data source.

29. A method as claimed in any one of claims 26 to 28 wherein more than one source metadata descriptor is mapped to at least one target meta-data descriptor.

30. A method as claimed in any one of claims 26 to 29 wherein meta-data descriptors of a plurality of source data sources are mapped to target meta-data descriptors of at least one target data source.

31. A method as claimed in any one of claims 26 to 30 wherein meta-data descriptors of a plurality of source data sources are mapped to target meta-data descriptors of a plurality of target data sources.

32. A method as claimed in any one of the preceding claims wherein data referenced by meta-data descriptors is remotely located.
Processing of Data

33. A method as claimed in any one of the preceding claims wherein the defined process is used to processed data.

34. A method as claimed in any of the preceding claims wherein the defined process is used to transform data extracted from one or more source data sources for supply to one or more target data sources.
Activities and Actions

35. A method as claimed in any of the preceding claims wherein an application is provided to enable the definition of an activity consisting of actions where at least one of the actions executes the defined process.

36. A method as claimed in claim 35 wherein the application is a graphical user application provided to enable a user to define the activity.

37. A method as claimed in claim 36 wherein the user defines new actions.

38. A method as claimed in any one of claims 35 to 37 wherein the activity is defined by a script.

39. A method as claimed in claim 38 wherein the script is written in a high-level programming language.

40. A method as claimed in any one of claims 35 to 39 wherein the activity contains an action which can stop the current activity until a different activity reaches a certain state.

41. A method as claimed in any one of claims 35 to 40 wherein the activity contains an action with the ability to start the execution of another activity either synchronously or asynchronously.

42. A method as claimed in any one of claims 35 to 41 wherein the activity contains an action with the ability to manipulate the environment of a computer system.

43. A method as claimed in any one of claims 35 to 42 wherein the activity contains an action which can execute defined processes, execute an email function, execute a program, pass parameters to an executing program, or set an internal flag.

44. A method as claimed in any one of claims 35 to 43 wherein the activity contains an action with the ability to control repetition of certain actions within the activity based upon programmatic manipulation of values within the data undergoing processing.

45. A method as claimed in any one of claims 35 to 44 wherein the activity is executed upon the occurrence of a trigger event.

46. A method as claimed in any one of claims 35 to 45 wherein the execution of an action is dependent on the occurrence of a trigger event.
Scheduling

47. A method as claimed in any one of the preceding claims wherein a schedule of the time or times for executing each activity is created and the activities are executed at the scheduled times.

48. A method as claimed in claim 47 wherein a user can schedule the times for execution of activities via a graphical interface.

49. A method as claimed in any one of claims 47 to 48 wherein the occurrence of time for executing each activity generates a trigger event.
Proxy Module

50. A method as claimed in any one of the preceding claims wherein a proxy module residing on a remote computer is utilised to accept data resulting from the processes and to modify data residing on the remote computer.

51. A method as claimed in any one of the preceding claims wherein a proxy module residing on a remote computer is utilised to extract data from the remote computer for the processes.
Trigger Events

52. A method as claimed in any one of claims 45 to 51 wherein the trigger event is a data and/or time.

53. A method as claimed in claim 45 to 52 wherein the trigger event is a type of data entry.

54. A method as claimed in any one of claims 45 to 53 wherein the trigger event is a specified change in status of an activity or action.

55. A method as claimed in any one of claims 45 to 54 wherein the trigger event is a specified change in status of a file system.

56. A method as claimed in any one of claims 45 to 55 wherein the trigger event is an occurrence of a specified state in a network system.

57. A method as claimed in any one of claims 45 to 56 wherein the trigger event is generated by the schedule.

58. A method as claimed in any one of the preceding claims when dependent upon claim 34 wherein the data resulting from the process and the associated meta-data descriptors are sent to the computer hosting the target data source for the host computer to update the target data source.

59. A method as claimed in any one of the preceding claims when dependent upon claim 34 wherein the data resulting from the process is sent to the computer hosting the target data source as a file to update the target data source.
Data Formats

60. A method as claimed in any preceding claim wherein the data is unstructured data.

61. A method as claimed in claim 60 wherein the data is a text file.

62. A method as claimed in claim 60 wherein the data is a telnet terminal session.

63. A method as claimed in any preceding claim wherein the data is structured data.

64. A method as claimed in claim 63 wherein the data is an HTML, EDI, IDOC, XML, CSV, text or a database file.

65. A computer implemented method of transforming selected data from one or more source data sources to one or more target data sources comprising the steps of:
iv) defining meta-data descriptors for the source data sources and for the target data sources;
v) in an interactive user application defining a transformation process between the source meta-data descriptors and the target meta-data descriptors; and
vi) transforming source data extracted from the source data sources in accordance with the defined transformation process to generate target data for supply to the target data sources.

66. A computer system for processing data comprising:
vi) a processor;
vii) memory for supplying data to the processor;
viii) an input device for providing user input to the processor;
ix) a display device for displaying information from the processor;
x) an application residing in memory which, when executed by the processor, is responsive to user input to define meta-data descriptors to represent data and to define a process associated with at least one of the meta-data descriptors; and to process the data in accordance with the defined process.

67. A computer system as claimed in claim 66 wherein the application defines meta-data descriptors by examining the data.

68. A computer system as claimed in claim 66 wherein the application defines meta-data descriptors by querying a database.

69. A computer system as claimed in claim 66 wherein user input from the input device assists the application in defining the meta-data descriptors.

70. A computer system as claimed in claims 66 to 69 wherein the application defines the process by displaying meta-data descriptors on the display device and accepting user input from the input device.

71. A computer system as claimed in claim 70 wherein the defined process includes transformation or manipulation operations all relating to meta-data descriptors.

72. A computer system as claimed in claim 71 wherein the transformation operations include programmatic or arithmetic operations.

73. A computer system as claimed in claims 70 to 72 wherein the user input comprises mouse or keyboard actions.

74. A computer system as claimed in claims 66 to 73 including: one or more data sources.

75. A computer system as claimed in claim 74 wherein one or more of the data sources reside on a remote system.

76. A computer system as claimed in any one of claims 66 to 75 including:
a proxy device.

77. A computer system as claimed in claim 76 when dependent on claim 75 wherein the proxy device resides on the remote system.

78. A computer system as claimed in claim 77 wherein the proxy device transfers data from the data sources on the remote system to the processor.

79. A computer system as claimed in claim 78 wherein the proxy device transfers data from the processor to the data sources on the remote system.

80. A computer system as claimed in any one of claims 66 to 79 including:
a timer device

81. A computer system as claimed in claim 80 wherein the application is responsive to user input to define times when an activity should occur and when times are reached as determined by the timer device executes the activities.

82. A computer system as claimed in claim 81 wherein the activity includes the defined process.

83. A computer system for processing data substantially as herein described with reference to FIGS. 7 to 25 of the accompanying drawings.

84. A computer implemented method of processing data substantially as herein described with reference to FIGS. 1 to 5 of the accompanying drawings.

85. A computer system for effecting the method of any one of the claims 1 to 65.

86. Software for effecting the method or system of any one of claims 1 to 85.

87. Storage media containing software as claimed in claim 86.

88. Data produced by the method, system or software or any one of the preceding claims.
